(19) United States
(12) Patent Application Publication
(10) Pub. No.: US 2024/0166205 A1
(43) Pub. Date: May 23, 2024

(54) MOVING OBJECT CONTROL SYSTEM, CONTROL METHOD THEREOF, STORAGE MEDIUM, AND MOVING OBJECT

(71) Applicant: HONDA MOTOR CO., LTD., Tokyo (JP)

(72) Inventors: Koki AIZAWA, Wako-shi (JP); Hideki MATSUNAGA, Wako-shi (JP); Ryoji WAKAYAMA, Wako-shi (JP); Kento SHIRAKATA, Wako-shi, Saitama (JP)

(21) Appl. No.: 18/385,665

(22) Filed: Oct. 31, 2023

(30) Foreign Application Priority Data
Nov. 18, 2022 (JP) 2022-184949

(51) Int. Cl. B60W 30/14; B60W 60/00

(52) U.S. Cl. CPC B60W 30/143; B60W 60/001; B60W 2420/42; B60W 2552/00

(57) ABSTRACT

The present invention is directed to a moving object control system comprising acquiring a captured image of a travel area to be a movement destination of a moving object; recognizing a road shape included in the captured image; generating a path of the moving object, based on the recognized road shape; and generating a speed plan of the moving object, based on the generated path and a recognition situation of the road shape.

### CROSS-REFERENCE TO RELATED APPLICATION(S)

This application claims priority to and the benefit of Japanese Patent Application No. 2022-184949, filed Nov. 18, 2022, the entire disclosure of which is incorporated herein by reference.

### BACKGROUND OF THE INVENTION

### Field of the Invention

The present invention relates to a moving object control system, a control method thereof, a storage medium, and a moving object.

### Description of the Related Art

In these years, compact moving objects are known such as electric vehicles called ultra-compact mobility vehicles (also referred to as micro mobility vehicles) each having a riding capacity of about one or two persons, and mobile robots that provide various types of services to humans. Some of such moving objects autonomously travel while periodically generating a travel route to a destination. Note that a compact moving object has insufficient hardware resources, and it is difficult to ensure an area for storing high-precision map information for generating a route and a communication device for acquiring a large amount of map information at high speed. Therefore, there is demand that such a compact moving object generate a route and control the speed in accordance with the generated route without using the high-precision map information.

Japanese Patent Laid-Open No. 2019-93740 proposes an automated driving system that makes a travel plan again, based on a current actual speed instead of changing a speed plan, when an operation intervenes to change braking force that acts on a vehicle, while travel control in accordance with a target route and a planned speed is being conducted. In addition, Japanese Patent Laid-Open No. 2022-106429 proposes a vehicle control device that recognizes a surrounding situation and conducts driving control in accordance with a target path candidate that satisfies a predetermined condition (limitation on a speed plan).

### SUMMARY OF THE INVENTION

In the related art described above, although consideration is given to controlling the speed in accordance with the target route or the like, the route generation is not performed without the high-precision map information, in the first place. On the other hand, in a case where the route generation is performed without the high-precision map information, it is necessary to analyze a captured image by a camera or the like provided in a moving object, recognize a road structure or the like, and generate a route in accordance with a recognition result. That is, the route is generated within an imaging range of the camera or the like, and the route can be generated in a stepwise manner in accordance with the movement of the moving object. For example, in a case where there is a course change in an intersection or the like, before entering the intersection or the like, the road shape after the course change has not yet been recognized and there is a possibility that the route has not yet been planned. In such a case, it is necessary to make a speed plan in accordance with a recognition situation of the road shape in order to assist the route generation and avoid sudden deceleration.

The present invention has been made in view of the above circumstances, and has an object to suitably make a speed plan in accordance with a recognition situation of a road shape, in a case where high-precision map information is not used.

According to one aspect the present invention, there is provided a moving object control system comprising: an imaging unit configured to acquire a captured image of a travel area to be a movement destination of a moving object; a recognition unit configured to recognize a road shape included in the captured image; a path generation unit configured to generate a path of the moving object, based on the road shape recognized by the recognition unit; and a speed planning unit configured to generate a speed plan of the moving object, based on the path generated by the path generation unit and a recognition situation of the road shape.

According to another aspect the present invention, there is provided a control method of a moving object control system, the control method comprising: acquiring a captured image of a travel area to be a movement destination of a moving object; recognizing a road shape included in the captured image; generating a path of the moving object, based on the recognized road shape; and generating a speed plan of the moving object, based on the generated path and a recognition situation of the road shape.

According to still another aspect the present invention, there is provided a non-transitory storage medium storing a program for causing a computer to function as: an imaging unit configured to acquire a captured image of a travel area to be a movement destination of a moving object; a recognition unit configured to recognize a road shape included in the captured image; a path generation unit configured to generate a path of the moving object, based on the road shape recognized by the recognition unit; and a speed planning unit configured to generate a speed plan of the moving object, based on the path generated by the path generation unit and a recognition situation of the road shape.

According to yet still another aspect the present invention, there is provided a moving object comprising: an imaging unit configured to acquire a captured image of a travel area to be a movement destination of a moving object; a recognition unit configured to recognize a road shape included in the captured image; a path generation unit configured to generate a path of the moving object, based on the road shape recognized by the recognition unit; and a speed planning unit configured to generate a speed plan of the moving object, based on the path generated by the path generation unit and a recognition situation of the road shape.

Further features of the present invention will become apparent from the following description of exemplary embodiments (with reference to the attached drawings).

### BRIEF DESCRIPTION OF THE DRAWINGS

FIGS. 1A and 1B are block diagrams each illustrating a hardware configuration example of a moving object according to the present embodiment;

FIG. 2 is a block diagram illustrating a control configuration of the moving object according to the present embodiment;

FIG. 3 is a block diagram illustrating a functional configuration of the moving object according to the present embodiment;

FIG. 4A is a diagram illustrating a captured image according to the present embodiment; and FIG. 4B is a diagram illustrating a road shape in the captured image according to the present embodiment;

FIG. 5 is a diagram illustrating an example of a speed planning method according to the present embodiment;

FIG. 6 is a diagram illustrating a hysteresis function according to the present embodiment;

FIG. 7 is a diagram illustrating an example of a path generation procedure in an intersection according to the present embodiment;

FIG. 8 is a diagram illustrating an example of a speed planning procedure in the intersection according to the present embodiment;

FIG. 9 is a flowchart illustrating a processing procedure for controlling traveling of the moving object according to the present embodiment; and

FIG. 10 is a flowchart illustrating a processing procedure of the speed plan of the moving object according to the present embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### <Configuration of Moving Object>

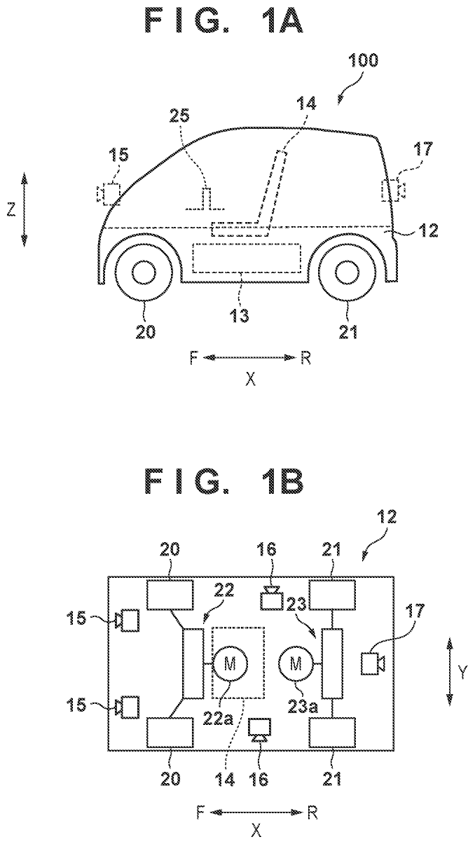

A configuration of a moving object 100 according to the present embodiment will be described with reference to FIGS. 1A and 1B. FIG. 1A illustrates a side surface of the moving object 100 according to the present embodiment, and FIG. 1B illustrates an internal configuration of the moving object 100. In the drawing, an arrow X indicates a front-and-rear direction of the moving object 100, and F indicates the front, and R indicates the rear. An arrow Y indicates a width direction (a left-and-right direction) and an arrow Z indicates an up-and-down direction of the moving object 100.

The moving object 100 includes a traveling unit 12, and is an ultra-compact mobility vehicle that moves mainly with the power of a motor using a battery 13 as a main power supply. The ultra-compact mobility vehicle is an ultra-compact vehicle that is more compact than a general automobile and that has a riding capacity of about one or two persons. In the present embodiment, an ultra-compact mobility vehicle of four wheels will be described as an example of the moving object 100, but there is no intention to limit the present invention. For example, a three-wheeled vehicle or a straddle type vehicle may be used. In addition, the moving object in the present invention is not limited to a vehicle, and may be a moving object that loads baggage and travels side by side with a person who is walking, or a moving object that leads a person. Furthermore, the present invention, without being limited to a four-wheeled or two-wheeled vehicle, is also applicable to a walking robot or the like capable of autonomously moving.

The battery 13 is, for example, a secondary battery such as a lithium ion battery, and the moving object 100 self-travels on the traveling unit 12 with electric power supplied from the battery 13. The traveling unit 12 is a four-wheeled vehicle including a pair of left and right front wheels 20 and a pair of left and right rear wheels 21. The traveling unit 12 may be in another form such as a form of a three-wheeled vehicle. The moving object 100 includes a seat 14 for one person or two persons. An operation unit 25 for an occupant to input a direction indication is provided in front of the seat 14. The operation unit 25 is an optional device for indicating a moving direction of the moving object 100, and for example, a device capable of inputting in multiple directions such as a joystick is applicable. Before entering a road shape having an exit accompanied by a course change, for example, an intersection or the like, a driver operates the operation unit 25, and is able to give an instruction to which direction of an exit the driver is intended to pass through.

The traveling unit 12 includes a steering mechanism 22. The steering mechanism 22 is a mechanism that changes the steering angle of the pair of front wheels 20 with a motor 22a as a drive source. An advancing direction of the moving object 100 can be changed by changing the steering angle of the pair of front wheels 20. The traveling unit 12 also includes a drive mechanism 23. The drive mechanism 23 is a mechanism that rotates the pair of rear wheels 21 with the motor 23a as a drive source. By rotating the pair of rear wheels 21, it is possible to move the moving object 100 forward or rearward.

The moving object 100 includes detection units 15 to 17, each of which detects a target in the surroundings of the moving object 100. The detection units 15 to 17 are an external sensor group that monitors the surroundings of the moving object 100. In the present embodiment, each detection unit is an imaging device that captures an image of the surroundings of the moving object 100, and includes, for example, an optical system such as a lens and an image sensor. However, instead of the imaging device or in addition to the imaging device, a radar or a light detection and ranging (LiDAR) is also adoptable.

Two detection units 15 are disposed in a front part of the moving object 100 to be spaced apart from each other in Y direction, and mainly detect a target on a forward side of the moving object 100. The detection unit 16 is disposed on each a left side part and a right side part of the moving object 100, and mainly detects a target on a lateral side of the moving object 100. The detection unit 17 is disposed in a rear part of the moving object 100, and mainly detects a target on a rearward side of the moving object 100. In addition, in the present embodiment, an example in which the detection units are provided on the front, rear, left, and right of the moving object 100 will be described. However, there is no intention to limit the present invention, and the detection units may be provided only in a certain direction (for example, on a front side) of the moving object 100.

The moving object 100 according to the present embodiment captures an image of a forward area of the moving object 100 using at least the detection unit 15, extracts a road shape from the captured image, and generates a route in accordance with recognition information indicating the road shape that has been extracted and an operation instruction on the operation unit 25 by the driver or information about a course change obtained from a route plan to a destination. As for the recognition information, a machine learning model output by a machine learning model that processes image information (captured images) performs, for example, arithmetic operations of a deep learning algorithm using a deep neural network (DNN), and recognizes a road shape included in the image information. The recognition information includes information of various lines and various lanes of roads, a lane in which the self-vehicle is located (Ego lane), various intersections (Intersection such as a crossing), entrances (Road entrance) to various roads, and the like.

### <Control Configuration of Moving Object>

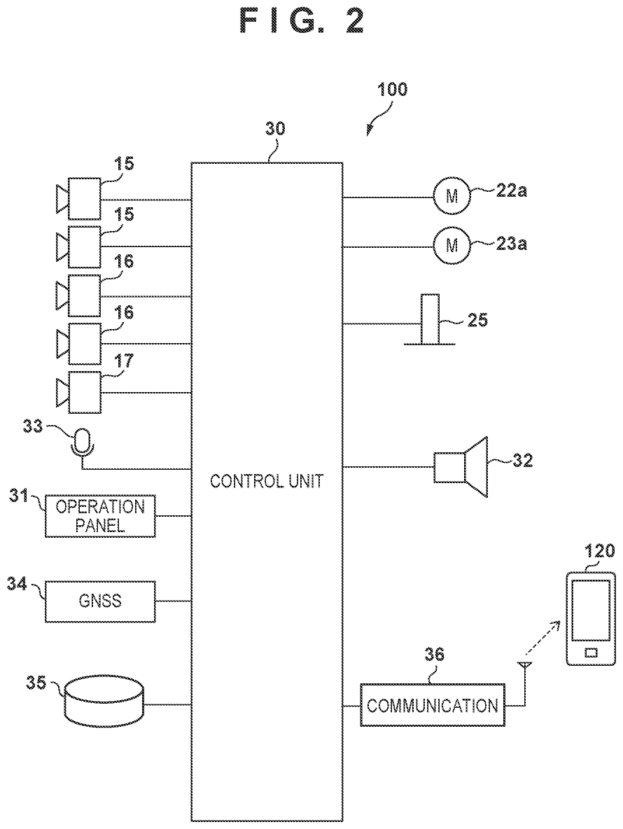

FIG. 2 is a block diagram of a control system of the moving object 100 according to the present embodiment. Here, a configuration necessary for carrying out the present invention will be mainly described. Therefore, any other configuration may be further included in addition to the configuration to be described below. In addition, in the present embodiment, a description will be given assuming that each element to be described below is included in the moving object 100, but there is no intention to limit the present invention. A moving object control system including a plurality of devices may be implemented. For example, some functions of a control unit 30 may be achieved by a server device communicably connected, or the detection units 15 to 17 or a GNSS sensor 34 may be provided as an external device. The moving object 100 includes the control unit (ECU) 30. The control unit 30 includes a processor represented by a CPU, a storage device such as a semiconductor memory, an interface with an external device, and the like. The storage device stores a program to be executed by the processor, data used for processing by the processor, and the like. A plurality of sets of the processor, the storage device, and the interface may be provided for each function of the moving object 100 to be communicable with one another.

The control unit 30 acquires detection results of the detection units 15 to 17, input information of an operation panel 31, voice information that has been input from a voice input device 33, position information from the GNSS sensor 34, direction indication information from the operation unit 25, and reception information via a communication unit 36, and performs corresponding processing. The control unit 30 controls the motors 22a and 23a (travel control of the traveling unit 12), controls display of the operation panel 31, notifies an occupant of the moving object 100 by sounds of a speaker 32, and outputs information.

The voice input device 33 collects sound of voices of the occupant of the moving object 100. The control unit 30 is capable of recognizing the sound of voices that have been input and performing corresponding processing. A global navigation satellite system (GNSS) sensor 134 receives a GNSS signal, and detects the current position of the moving object 100. A storage device 35 is a storage device for storing captured images by the detection units 15 to 17, obstacle information, routes that have been generated in the past, an occupancy grid map, and the like. The storage device 35 may also store a program to be executed by the processor, data used for processing by the processor, and the like. The storage device 35 may store various parameters (for example, learned parameters, hyperparameters, and the like of the deep neural network) of a machine learning model for voice recognition and image recognition to be performed by the control unit 30.

The communication unit 36 communicates with a communication device 120, which is an external device, through wireless communication such as Wi-Fi or the 5th generation mobile communication. The communication device 120 is, for example, a smartphone, without being limited to this, or may be an earphone-type communication terminal, a personal computer, a tablet terminal, a game machine, or the like. The communication device 120 is connected to a network through the wireless communication such as Wi-Fi or the 5th generation mobile communication.

The user who possesses the communication device 120 is able to give an instruction to the moving object 100 via the communication device 120. The instruction includes, for example, an instruction for calling the moving object 100 to come to a position desired by the user and join together. Upon receipt of the instruction, the moving object 100 sets a target position based on position information included in the instruction. Note that in addition to such an instruction, the moving object 100 is capable of setting the target position from the captured images of the detection units 15 to 17, or is capable of setting the target position based on an instruction from the user who is in the moving object 100 via the operation panel 31. In a case of setting the target position from a captured image, for example, a person who raises his/her hand for the moving object 100 is detected in the captured image, and the position of the detected person is estimated and set as the target position.

### <FUNCTIONAL CONFIGURATION OF MOVING OBJECT>

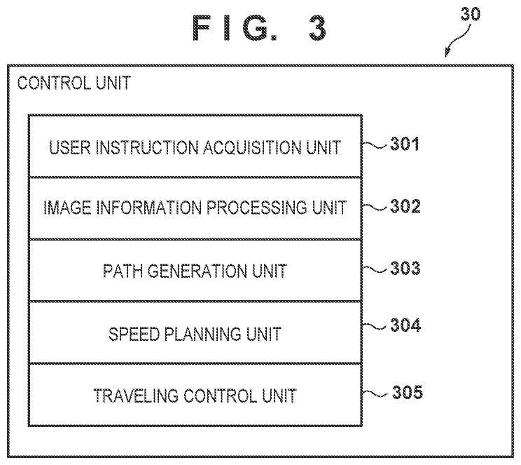

Next, a functional configuration of the moving object 100 according to the present embodiment will be described with reference to FIG. 3. In the control unit 30, the functional configuration described here is implemented, for example, by the CPU reading a program stored in a memory such as a ROM into a RAM and executing the program. Note that regarding the functional configuration to be described below, descriptions of only functions necessary for describing the present invention will be given, but descriptions of all functional configurations actually included in the moving object 100 will not be given. That is, the functional configuration of the moving object 100 according to the present invention is not limited to the functional configuration to be described below.

A user instruction acquisition unit 301 has a function of receiving an instruction from the user, and is capable of receiving a user instruction via the operation unit 25 or the operation panel 31, a user instruction from an external device such as the communication device 120 via the communication unit 36, and an instruction by an utterance of the user via the voice input device 33. As described above, the user instruction includes an instruction to set a target position (also referred to as a destination) of the moving object 100 and an instruction related to the travel control of the moving object 100.

An image information processing unit 302 processes the captured images that have been acquired by the detection units 15 to 17. Specifically, the image information processing unit 302 extracts a road shape that has been recognized from the captured images acquired by the detection units 15 to 17. In addition, the image information processing unit 302 may include a machine learning model that processes image information, and may perform processing on a learning stage and processing on an inference stage of the machine learning model. By performing arithmetic operations of a deep learning algorithm using the deep neural network (DNN), for example, the machine learning model of the image information processing unit 302 is capable of performing processing of recognizing a road shape or the like included in the image information. The recognition information indicating the recognized road shape includes, for example, information indicating a line such as a white line, a lane, a shape of an intersection, an entrance and an exit of the intersection, and the like.

A path generation unit 303 generates a travel route (path) of the moving object 100 to a target position that has been set by the user instruction acquisition unit 301. Specifically, the path generation unit 303 generates a path based on the road shape (recognition information) that has been recognized from the captured images of the detection units 15 to 17 and the direction indication information via the operation unit 25, without necessitating obstacle information on a high-precision map. Note that the recognition information is information of road shapes in a predetermined range from the moving object 100, and it is not possible to recognize road shapes farther than such a range. On the other hand, the recognition information is information periodically updated, as the moving object 100 advances. Therefore, a distant area is gradually recognized in accordance with the movement of the moving object 100. The path generation unit 303 generates the path in a sequential manner in accordance with the recognition information to be updated. In addition, the direction indication information is not limited to the information received via the operation unit 25, and may be based on information on a course change obtained by a route plan to a destination. Therefore, in the present invention, the operation unit 25 is not an essential configuration, and the present invention is applicable to a moving object or the like that does not include the operation unit 25.

Further, a speed planning unit 304 plans the speed in accordance with the curvature of the path that has been generated by the path generation unit 303, and plans the speed, based on the direction indication by the driver and the accuracy of the recognized road shape. For example, when an instruction to turn to the left or right is given in an intersection or the like, control is conducted in the speed plan so that the vehicle decelerates to 8 km in a case of turning to the right, or decelerates to 6 km in a case of turning to the left, before starting to curve from moving straight ahead. By controlling the speed in accordance with the path that has been generated in this manner and the instruction from the driver, rapid deceleration or the like can be avoided. In addition, in a case where recognition accuracy of the road shape is high, the deceleration is set to be low, whereas in a case where the recognition accuracy is low, the deceleration is set to be high. The recognition accuracy can be determined in accordance with, for example, a parameter given to a road structure indicating the road shape that has been recognized by the image information processing unit 302. Details will be described later.

A travel control unit 305 controls traveling of the moving object 100 in accordance with the path and the speed plan that have been generated. Specifically, the travel control unit 305 controls the traveling unit 12 in accordance with the path and the speed plan to control the speed and an angular velocity of the moving object 100. When a deviation occurs in a driving speed plan of the path due to an operation of the driver, the travel control unit 305 may acquire a new path generated by the path generation unit 303 again and control the traveling, or may control the speed and the angular velocity of the moving object 100 so as to eliminate the deviation from the path in use.

### <Captured Image>

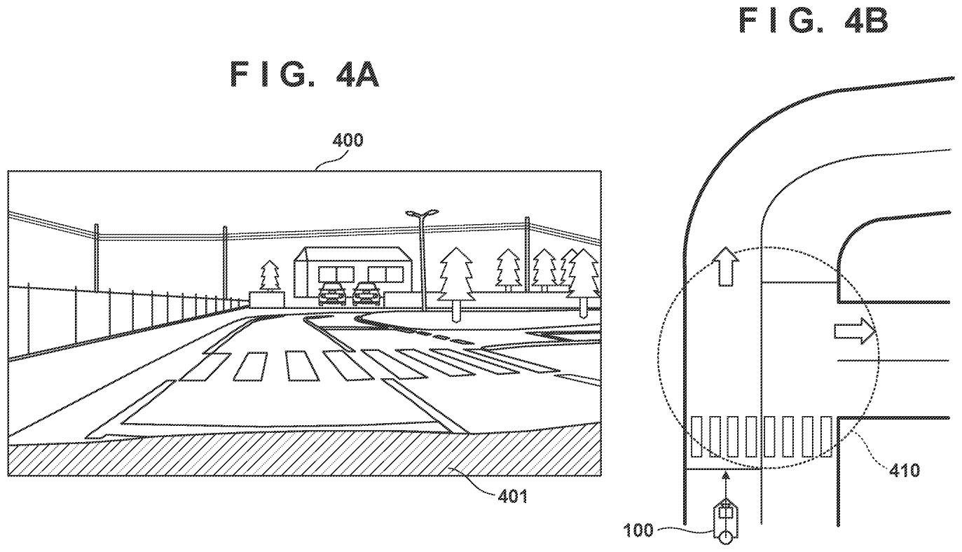

FIG. 4A illustrates a captured image, and FIG. 4B illustrates an example of a road shape included in the captured image according to the present embodiment. A captured image 400 illustrated in FIG. 4A indicates an image that has been captured by the detection unit 15 provided in the front part of the moving object 100. Note that a shaded area 401 indicates the inside of the cockpit of the moving object 100 that has been captured and included in the captured image 400. Areas other than the shaded area 401 are areas where surrounding environments spreading on a forward area of the moving object 100 have been captured.

FIG. 4B illustrates a road shape included in the captured image 400 illustrated in FIG. 4A. A dotted area 410 indicates an intersection of a three-way junction (T junction). As illustrated in FIG. 4B, in the forward area of the moving object 100, an intersection of a three-way road is present on a near side, and an exit after moving straight ahead in the advancing direction and an exit when turning to the right are present as exits from the intersection. A road largely curved to the right is continuous ahead of the exit when moving straight through the intersection. As illustrated in the captured image 400, in a viewpoint from the moving object 100 before entering the intersection 410, it is possible to recognize that a plurality of exits indicated by arrows are present, but it is not possible to recognize the road shapes ahead of the exits. Therefore, the moving object 100 according to the present embodiment generates a path in a sequential or stepwise manner using the road shape to be clarified as it moves, and makes a speed plan. That is, as the moving object 100 approaches a predetermined road shape, the accuracy of the recognition increases, and the moving object 100 generates the path and the speed plan in accordance with the degree of recognition. In addition, in a case where a plurality of exit sections are included in the road shape that has been recognized from the captured image 400, or in a case where at least one exit section is located outside a predetermined range from the current advancing direction, the moving object 100 according to the present embodiment determines that the road shape includes at least one exit section accompanied by a course change. In a case of such a determination, according to the present embodiment, it is determined that there is a possibility of the course change, and path generation to be described later is performed. In addition, regarding the speed plan, when direction indication information accompanied by a course change is acquired, deceleration may be started, or when at least one exit section accompanied by the course change is recognized, the deceleration may be started. In this manner, according to the present embodiment, in a case where there is a possibility of the course change, the deceleration is started in preparation for the course change.

### <Speed Planning Method>

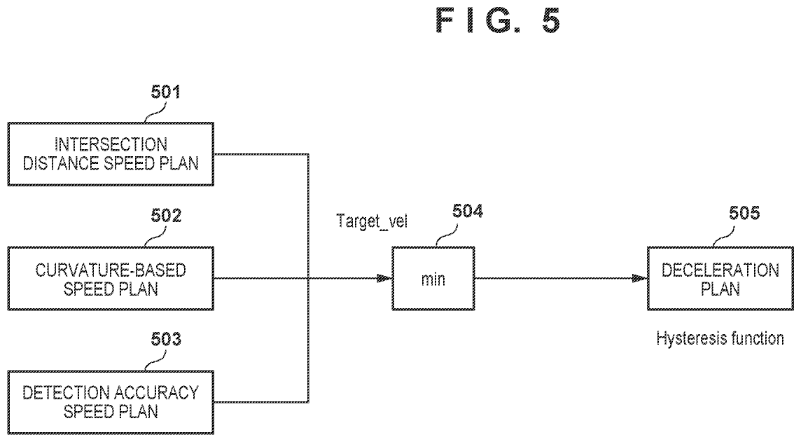

FIG. 5 illustrates an example of a speed planning method according to the present embodiment. Here, a functional configuration of the speed plan by the speed planning unit 304 will be described. The speed plan of the moving object 100 according to the present embodiment is made in accordance with a recognition situation of a road shape of the intersection or the like by the image information processing unit 302. The speed planning unit 304 includes an intersection distance speed plan 501, a curvature-based speed plan 502, and a detection accuracy speed plan 503, as functional configurations.

In the intersection distance speed plan 501, the speed plan is generated in accordance with the distance to an entrance section of an intersection or the like that has been recognized by the image information processing unit 302. Specifically, here, a speed plan for decelerating to a target speed in accordance with a movement destination direction of the moving object 100 after entering the intersection is generated. For example, in a case where the moving direction is a left-turn direction accompanied by a course change, the speed of the moving object 100 is planned to be 6 km/h in an entrance section of the recognized intersection or the like. In addition, in a case where the moving direction is a right-turn direction accompanied by a course change, the speed of the moving object 100 is planned to be 8 km/h in the entrance section of the recognized intersection or the like. Furthermore, in a case where the moving direction is moving straight ahead, the speed of the moving object 100 is planned to be 10 km/h in the entrance section of the recognized intersection or the like. Note that these numerical values are merely examples, and do not limit the present invention. Turning to the left or right is determined, based on an operation instruction for turning to the left or right on the operation unit 25 or information about a course change obtained from a route plan to a destination. In addition, the deceleration value in accordance with the speed plan may be selected from a plurality of discontinuous candidate values. These candidate values are recorded in the storage device 35 beforehand.

In the curvature-based speed plan 502, the speed plan is generated in accordance with the path that has been generated by the path generation unit 303, particularly, in accordance with its curvature. Here, a speed plan is generated in accordance with the generated path so that sudden turning or sudden deceleration does not occur within a range of a limited speed. In addition, the curvature-based speed plan 502 generates a speed plan to change the speed of the moving object in accordance with a generation situation of the generated path. For example, as the generated path is longer, the speed of the moving object 100 is adjusted to be higher.

Further, the detection accuracy speed plan 503 generates a speed plan in accordance with recognition accuracy of the road shape recognized by the image information processing unit 302. For example, the speed plan is made such that as the recognition accuracy of the road shape becomes higher, the speed is higher, and as the recognition accuracy becomes lower, the speed is lower. In other words, the speed plan is made such that as the recognition accuracy of the road shape is higher, the deceleration value becomes smaller, and as the recognition accuracy is lower, the deceleration value becomes larger. Accordingly, in a state in which the road shape has not yet been recognized clearly, the speed of the moving object 100 is suppressed, so that the priority can be given to the recognition of the road shape. On the other hand, when the road shape is clearly recognized, the generated path also becomes longer, and the speed of the moving object 100 can be increased. Note that the recognition situation of the road shape can be determined by referring to parameters of the recognition information output from the image information processing unit 302. As described above, the parameters include information of various lines and various lanes of roads, a lane in which the self-vehicle is located (Ego lane), various intersections (Intersection such as a crossing), entrances (Road entrance) to various roads, and the like, and the parameters are increased, whenever a parameter can be recognized. Therefore, in the intersection, when its entrance section, all exit sections, and the road information (parameters) ahead of them can be recognized, it can be determined that the intersection can be clearly recognized.

In this manner, in the moving object 100 according to the present embodiment, a plurality of speed plans are generated as needed, based on various conditions. The plurality of speed plans (speed values) that have been generated are input into a minimization block 504, and the speed plan with a smallest speed value is selected. Note that the speed plan is not always output from the functional configurations of 501 to 503, but is generated as needed at a timing when each functional configuration is capable of generating the speed plan, and then an input is generated. Therefore, in a case where there are a plurality of inputs at the same time, the speed plan having the minimum speed value among them is selected and input into the functional configuration of a deceleration plan 505 subsequently. In the deceleration plan 505, a deceleration value of the moving object 100 is determined, based on a current speed of the moving object 100 and the speed plan that has been input. Note that although the deceleration value is described as an example here, acceleration is also performed after a course change or the like. In such a case, an acceleration value is used. That is, here, an acceleration value or a deceleration value is generated in accordance with the speed plan.

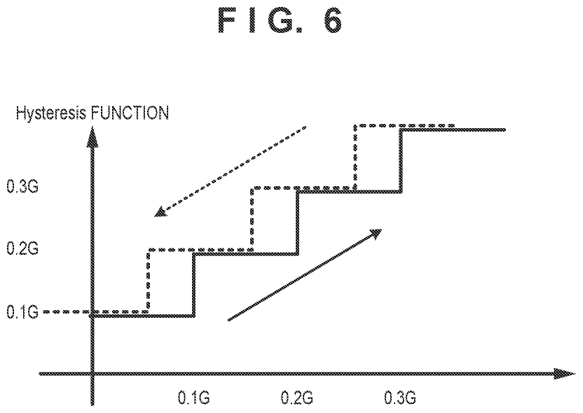

In addition, in a case where the deceleration value is changed, control using a hysteresis function as illustrated in FIG. 6 is conducted. In FIG. 6, the horizontal axis represents a deceleration value input into the deceleration plan 505, and the vertical axis represents a deceleration value output from the deceleration plan 505. In addition, a solid line indicates when the deceleration value increases, and a dotted line indicates when the deceleration value decreases. In normal deceleration, it is preferable to decelerate at 0.1 G, but depending on the timing of a direction indication or the like, the target speed may not be achievable in some cases, unless deceleration equal to or higher than 0.1 G is performed. On the other hand, if a deceleration value for making the deceleration G variable is sequentially calculated, the moving object 100 will vibrate violently, and this will adversely affect a riding comfort. Therefore, according to the present embodiment, as illustrated in FIG. 6, the deceleration value is changed with a hysteresis.

### <Path Generation Procedure in Intersection or the Like>

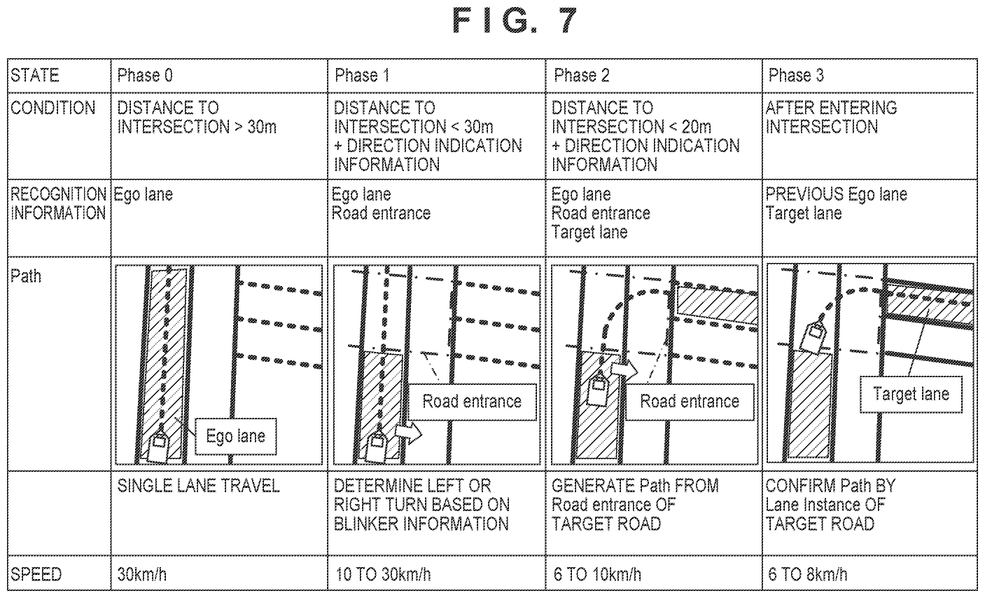

FIG. 7 illustrates a path generation procedure in accordance with a recognition situation of an intersection according to the present embodiment. Here, a description will be given with regard to a path generation procedure when approaching the intersection (T junction) illustrated in FIG. 4B. According to the present embodiment, a path in passing through a road shape of an intersection or the like including an entrance section and an exit section accompanied by a course change is generated in a sequential (stepwise) manner in accordance with recognition information of the road shape obtained from a captured image.

Here, an example in which path control is conducted on four stages in accordance with the distance between the moving object 100 and an intersection will be described. As illustrated in FIG. 7, Phase 0 is a state in which the distance from the moving object 100 to the intersection is more than 30 m. In this state, from the captured images that have been acquired by the detection units 15 to 17, the image information processing unit 302 recognizes “Ego lane” indicating a travel area where the moving object 100 is traveling, but does not recognize the road shape of the intersection.

Phase 1 is a state in which the distance from the moving object 100 to the intersection is shorter than 30 m and an instruction to turn to the right has been received from the operation unit 25. In this state, the image information processing unit 302 is capable of recognizing the intersection, in addition to the above “Ego lane”. Note that regarding the recognition information of the intersection here, although the shape of the intersection and the entrance section (“Road entrance”) are recognized, the exit section (Exit) or the travel area ahead of the intersection has not yet been recognized clearly.

The recognition information (for example, “Intersection” indicating an intersection or the like) of the road shape that has been extracted by the image information processing unit 302 using the machine learning model includes various parameters in accordance with the recognition situation. The parameters include, for example, “Road entrance” indicating an entrance section or an exit section accompanied by a course change, information indicating a boundary of “Intersection”, information indicating a white line (Line) of a road shape in the vicinity, information indicating a lane (Travel area, Lane, and the like). That is, depending on the recognition situation, only the parameter indicating the shape (Boundary) of the “Intersection” is included in some cases, and there is a possibility that a lane or a line of a branch destination has not yet been recognized.

Therefore, the path generation unit 303 has to generate and update the path in a sequential manner in accordance with such a recognition situation. In such Phase 1, although an instruction to turn to the right has been received, an exit section (Exit) of the intersection or a travel area ahead of it has not yet been identified. Therefore, the path generation unit 303 maintains the current path as a path, and does not generate a path for changing the course.

Phase 2 is a state in which the distance from the moving object 100 to the intersection is shorter than 20 m and an instruction to turn to the right has been received from the operation unit 25. In this state, the image information processing unit 302 recognizes a travel area “Target lane” ahead of it, in addition to the recognition information of the above Phase 1, and extracts an exit section to such a travel area. Note that here, although the travel area “Target lane” is recognized, the line indicating the boundary of the travel area has not yet been recognized, and the accuracy of the recognition of the travel area is low. On the other hand, an exit section “Road entrance” of the intersection in the case of turning to the right as instructed has been recognized clearly. This is because, for example, in Phase 2, as approaching the intersection, it becomes possible to clearly recognize the boundary of the intersection on a right-turn side, estimate its upper half as the traveling lane (travel area “Target lane”), and estimate its lower half as an opposite lane.

Therefore, in Phase 2, the path generation unit 303 generates a path for a course change, based on information that can be recognized with higher accuracy. Specifically, the path generation unit 303 generates a first path from a current position of the moving object 100 to an already recognized entrance section “Road entrance” of the intersection and a second path from such an entrance section to an exit section “Road entrance” of the intersection on the right-turn side. The second path is generated to include a path of at least one curve such as a single curve, a clothoid curve, and a cubic curve. The second path may include a straight line in addition to such a curve. In addition, the second path may be generated as a path from the center of the entrance section to the center of the exit section that has been identified.

Phase 3 is a state in which the moving object 100 has entered the intersection. In this state, in addition to the recognition information of the above Phase 2, the image information processing unit 302 is capable of further recognizing a white line (Line) indicating a boundary of a travel area “Target lane” ahead of it, and is capable of recognizing the travel area “Target lane” more accurately than Phase 2. Therefore, in Phase 3, the path generation unit 303 generates a third path to be continuous with the second path that has been generated in Phase 2 and that is in the recognized travel area. Accordingly, it becomes possible to generate a path when a right-turn instruction is given in an intersection.

Note that in the above Phase 3, the description has been given with regard to an example in which after the moving object 100 enters the intersection, the white line (for example, a line indicating a boundary of a lane “Lane instance”) of the travel area “Target lane” is recognized, and the third path is generated at a timing when the travel area “Target lane” is more accurately confirmed. However, there is no intention to limit the present invention. For example, instead of the timing when the travel area “Target lane” is confirmed as described above, the path generation unit 303 may determine that the travel area “Target lane” is confirmed to some extent and generate the third path, when the moving object 100 moves ahead of the entrance section into the intersection. Note that the timing when the moving object 100 moves ahead of the entrance section into the intersection is, that is, the timing when traveling on the second path is started. Alternatively, when the moving object 100 approaches a location by a predetermined distance from the exit section on the right-turn side that has been identified, the path generation unit 303 may determine that the travel area “Target lane” has been confirmed to some extent and generate the third path.

In addition, in the present invention, the description has been given with regard to an example in which a course change such as turning to the left or right is determined, based on the direction indication information from the operation unit 25. However, there is no intention to limit the present invention. For example, when it is necessary to turn to the right in the next intersection while the route plan is being conducted in accordance with a preset destination, the path generation unit 303 may determine turning to the right and generate the path without receiving the direction indication information as described above. In addition, for example, the end of the road is present in the advancing direction, and it is necessary to turn to the left or right. In a case where the direction indication information from the operation unit 25 is not received, it may be determined to turn to the left or right and a path may be generated. In this case, for example, a course change in a direction approaching the destination is selectable for the route plan to the destination.

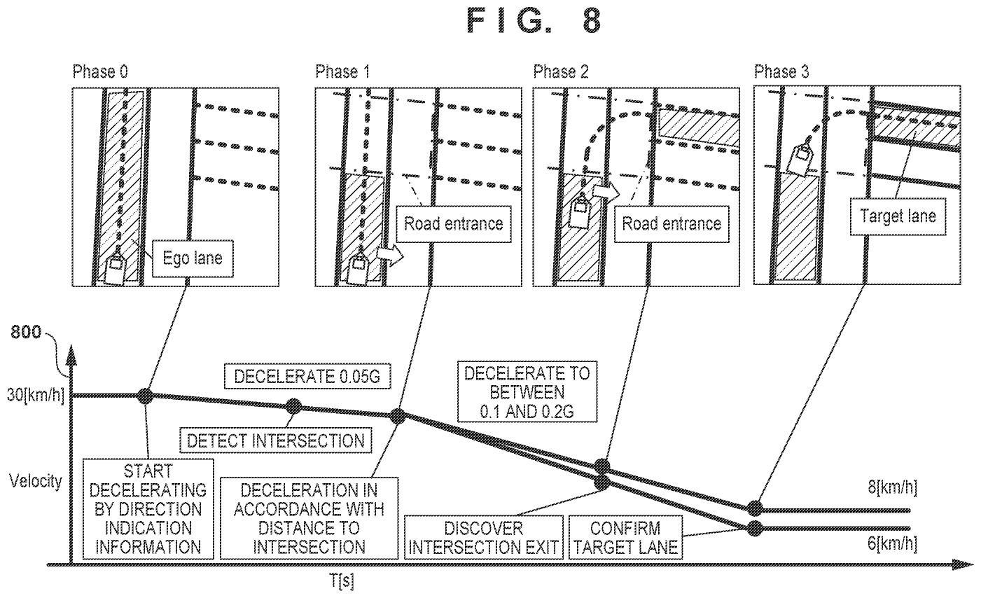

Further, according to the present embodiment, the speed planning unit 304 plans a target speed in each Phase, as illustrated in the row “speed” in FIG. 7. For example, when an instruction to turn to the left or right is received in a state in which an intersection has been recognized, a course change will occur. Therefore, it is necessary to decelerate to a predetermined speed (for example, the speed is 8 km/h for turning to the right, and 6 km/h for turning to the left), before reaching an entrance section of the intersection. Therefore, it is desirable that the speed planning unit 304 decelerates in a stepwise manner in each Phase in order to avoid sudden deceleration. A specific deceleration method will be described with reference to FIG. 8.

### <Speed Plan for Intersection or the Like>

FIG. 8 illustrates a speed planning procedure in accordance with a recognition situation of a road shape of an intersection or the like according to the present embodiment. In a graph 800, the horizontal axis represents time (s), and the vertical axis represents the speed (km/h) of the moving object 100. Here, a speed plan when the moving object 100 approaches the T junction illustrated in FIG. 4 will be described. Note that in the present embodiment, a description will be given with use of a T junction as an example of a road shape including an entrance section and an exit section (Exit) accompanied by a course change. However, in the present invention, the travel area such as an intersection having a road shape including an entrance section and an exit section (Exit) accompanied by a course change, a T junction, an entrance to a facility along a road, or a travel area having a letter L shape may be applicable. The entrance to the facility along the road includes, for example, an entrance to a shopping mall, a gas station, a parking lot, or the like.

First, regardless of whether an intersection or the like has been detected, upon receipt of the direction indication information via, for example, the operation unit 25, the speed planning unit 304 determines that a course change is to be made in a received direction in the next intersection or the like, and starts deceleration (Phase 0 described above). The deceleration value here is determined to be a predetermined value such as 0.05 G. In addition, the speed may be determined in accordance with the current speed of the moving object 100. Note that with regard to the timing of receiving the direction indication information, the timing is likely to be after having detected the intersection or the like. Depending on the current speed of the moving object 100, when an intersection or the like is detected first, deceleration may be started before receiving the direction indication information.

After the image information processing unit 302 detects an intersection or the like, when an entrance section “Road entrance” of the intersection or the like is further recognized, the distance to the intersection or the like is recognized (Phase 1 described above). Here, the speed planning unit 304 updates the deceleration value in accordance with a target speed (for example, the speed is 8 km/h for turning to the right, and 6 km/h for turning to the left) to the entrance section of the intersection or the like. For example, the value is updated to between 0.1 G and 0.2 G.

Then, when an exit section “Road entrance” of the intersection or the like is recognized (Phase 2) and a path in the intersection is generated, a speed plan is generated by the curvature-based speed plan 502 and the deceleration value is adjusted as necessary. Note that, before and after Phase 3, the moving object 100 has reached the entrance section of the intersection or the like, and thus has been decelerated to the target speed. Furthermore, when a target lane is determined and a path after passing through the exit section is generated (Phase 3 described above), a speed plan is newly generated by the curvature-based speed plan 502, and the deceleration value is adjusted as necessary.

In addition, when passing through the intersection or the like, the detection accuracy speed plan 503 generates a speed plan in accordance with the recognition accuracy of the intersection or the like. In a case where a plurality of speed plans are generated, the minimum speed is selected and the deceleration value is determined, as described with reference to FIG. 5.

### <Basic Flow>

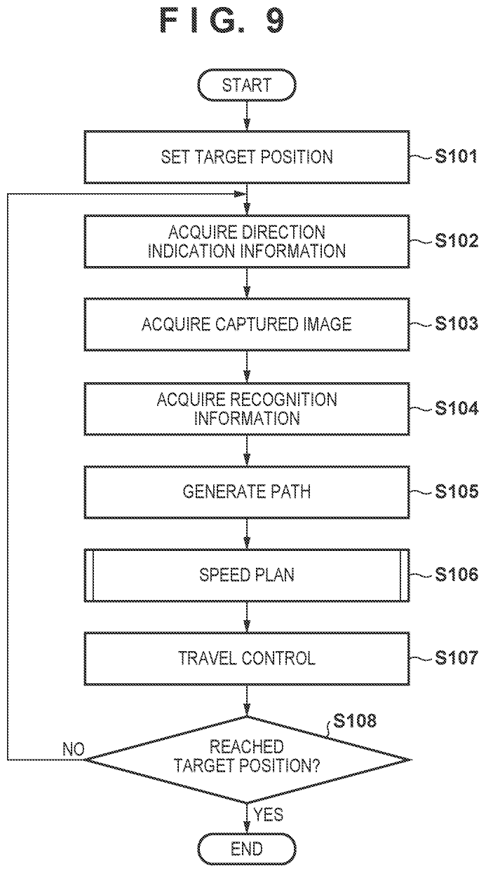

FIG. 9 is a flowchart illustrating basic control of the moving object 100 according to the present embodiment. Regarding processing to be described below, in the control unit 30, for example, the CPU reads a program stored in a memory such as a ROM into a RAM, and executes the program, thereby implementing the processing.

In S101, the control unit 30 sets a target position of the moving object 100, based on a user instruction that has been received by the user instruction acquisition unit 301. The user instruction can be received in various methods as described above. Subsequently, in S102, the control unit 30 acquires direction indication information. Here, direction indication information when the driver operates the operation unit 25 and direction indication information of a course change determined in accordance with a set destination position are included. Here, as processing of acquiring the direction indication information, the processing performed in S102 is described for the sake of convenience. However, in practice, the processing is performed at any time as interruption processing at a timing when the driver operates the operation unit 25. Therefore, also after the processing of S102, the direction indication information is acquired by an operation interruption, and is used for path generation.

Next, in S103, the detection unit 15 captures an image of a forward area (the advancing direction) of the moving object 100, and the control unit 30 acquires the captured image. Then, in S104, the image information processing unit 302 processes the captured image that has been acquired, and the control unit acquires recognition information indicating a road shape that has been recognized by using the machine learning model. Note that the processing of S103 and the processing of S104 are continuously or periodically performed, and the captured image and the recognition information acquired from the captured image are information to be updated as needed.

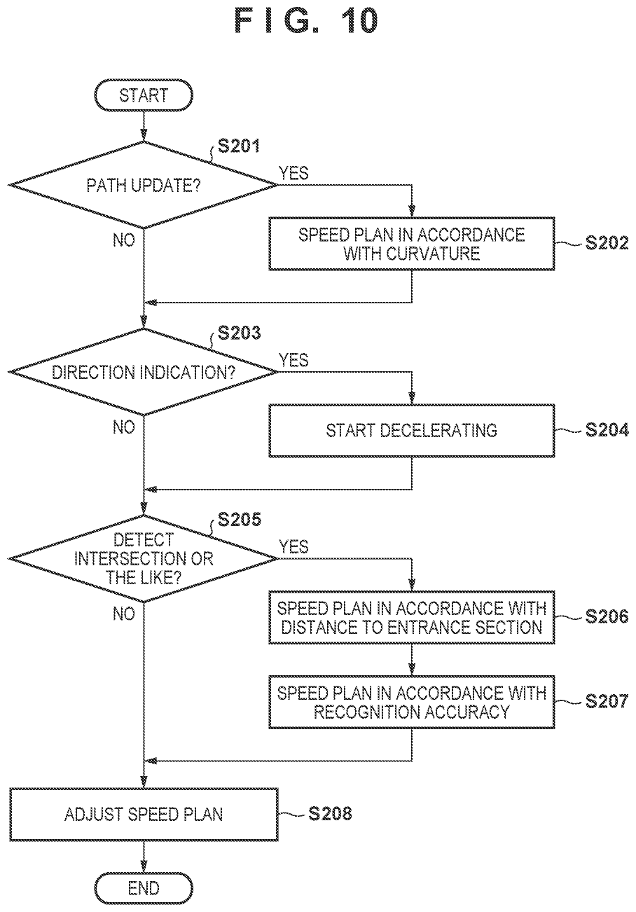

Next, in S105, the control unit 30 causes the path generation unit 303 to generate a path of the moving object 100 in accordance with the recognition information acquired in S104. Subsequently, in S106, the control unit 30 generates a speed plan of the moving object 100, based on the generated path, the direction indication information, and the recognition information. A detailed procedure of the speed plan by the speed planning unit 304 will be described later with reference to FIG. 10. Furthermore, in S107, the control unit 30 causes the travel control unit 305 to determine the speed and the angular velocity of the moving object 100, and controls traveling. Then, in S108, the control unit 30 determines whether the moving object 100 has reached the target position, based on the position information from the GNSS sensor 34, and in a case where the moving object 100 has not reached the target position, the control unit 30 returns the processing to S102, generates a path while updating the captured image, and repeatedly performs processing of controlling traveling. On the other hand, in a case where the moving object 100 has reached the target position, the processing of this flowchart ends.

### <Processing Procedure of Speed Plan>

FIG. 10 is a flowchart illustrating a detailed processing procedure of the speed plan (S106) according to the present embodiment. Regarding processing to be described below, in the control unit 30, for example, the CPU reads a program stored in a memory such as a ROM into a RAM, and executes the program, thereby implementing the processing.

First, in S201, the speed planning unit 304 determines whether the path is updated in S105. In a case where the path is updated, the processing proceeds to S202, and in a case where the path is not updated, the processing proceeds to S203. In S202, the speed planning unit 304 generates a speed plan in accordance with an updated curvature of the path. Here, the speed from the current position of the moving object 100 to an end point of the generated path is planned, and the processing proceeds to S203. On the other hand, in a case where there is no change in the path that has been generated up to a previous time, only the speed plan for a part of the path that has been newly generated may be generated.

In S203, the speed planning unit 304 determines whether the direction indication information is received in S102. In a case where it is received, the processing proceeds to S204, and in a case where it is not received, the processing proceeds to S205. Since the direction indication information is received in S204, the speed planning unit 304 determines that a course change will occur, and starts deceleration, and the processing proceeds to S205. Here, the deceleration is started at a predetermined deceleration value, for example, 0.05 G.

In S205, the speed planning unit 304 determines whether an intersection or the like has been detected in the recognition information acquired in S104. In a case where it has been detected, the processing proceeds to S206, and in a case where it has not been detected, the processing proceeds to S208. When an entrance section of the intersection that has been detected is recognized in S206, the speed planning unit 304 generates a speed plan to the entrance section to decelerate to a predetermined speed in accordance with a distance from the moving object 100 to the entrance section and a course change direction. Subsequently, in S207, the speed planning unit 304 generates a speed plan in accordance with the recognition accuracy of the intersection or the like, and the processing proceeds to S208.

In S208, the speed planning unit 304 adjusts the currently performed speed plan by using the respective speed plans generated in S202, S206, and S207, ends the processing of the present flowchart, and returns the processing to S107. As for the adjustment method, for example, as described with reference to FIG. 5, a speed plan that minimizes the speed may be selected. Note that the processing of S206 is omitted, in a case where the speed plan to the entrance section of the intersection or the like has already been generated.

### Summary of Embodiments

1. A moving object control system (e.g. 100) according to the above embodiments comprising:
   an imaging unit (e.g. 15-17) configured to acquire a captured image of a travel area to be a movement destination of a moving object;
   a recognition unit (e.g. 302) configured to recognize a road shape included in the captured image;
   a path generation unit (e.g. 303) configured to generate a path of the moving object, based on the road shape recognized by the recognition unit; and
   a speed planning unit (e.g. 304) configured to generate a speed plan of the moving object, based on the path generated by the path generation unit and a recognition situation of the road shape.

According to this embodiment, in a case where high-precision map information is not used, the speed plan can be suitably made in accordance with a recognition situation of the road shape.
2. In the moving object control system according to the above embodiments, wherein upon acquisition of direction indication information accompanied by a course change, the speed planning unit generates the speed plan to start deceleration of the moving object.

According to this embodiment, by starting the deceleration in advance before changing the course, sudden deceleration when actually starting to make a turn can be avoided.
3. In the moving object control system according to the above embodiments, wherein when the recognition unit recognizes the road shape including an entrance section, the speed planning unit determines a deceleration value of the moving object in accordance with a distance from a current position of the moving object to the entrance section.

According to this embodiment, in making a course change, turning can be started at an optimum speed.
4. In the moving object control system according to the above embodiments, wherein the speed planning unit determines the deceleration value to the entrance section to decelerate a speed of the moving object to a target speed corresponding to each course change direction.

According to this embodiment, turning can be started at an optimum speed in accordance with the course change direction.
5. In the moving object control system according to the above embodiments, wherein the target speed is further determined in accordance with a curvature of the path generated by the path generation unit.

According to this embodiment, the speed plan can be made to avoid sudden deceleration and sudden turning in accordance with the curvature of the generated path.
6. In the moving object control system according to the above embodiments, wherein the target speed is a predetermined value.

According to this embodiment, turning can be started at an optimum speed in accordance with a radius that is different depending on turning to the left or right.
7. In the moving object control system according to the above embodiments, wherein the speed planning unit selects the deceleration value from a plurality of discontinuous candidate values.

According to this embodiment, the processing load can be reduced, as compared with a case where calculation is performed every time.
8. In the moving object control system according to the above embodiments, wherein the speed planning unit changes the deceleration value with a hysteresis.

According to this embodiment, in the deceleration in accordance with the speed plan, sudden deceleration can be avoided.
9. In the moving object control system according to the above embodiments, wherein the speed planning unit further changes the deceleration value in accordance with recognition accuracy of the road shape by the recognition unit.

According to this embodiment, the recognition of the road shape can be supported by switching the speed in accordance with the recognition accuracy.
10. In the moving object control system according to the above embodiments, wherein
   the speed planning unit decreases the deceleration value, as the recognition accuracy of the road shape increases, and
   the speed planning unit increases the deceleration value, as the recognition accuracy of the road shape decreases.

According to this embodiment, in accordance with the recognition accuracy, the priority can be given to the traveling speed, or the recognition of the road shape can be supported.
11. In the moving object control system according to the above embodiments, wherein the speed planning unit further changes the speed of the moving object in accordance with a generation situation of the path by the path generation unit.

According to this embodiment, unnecessary deceleration can be avoided, although the path has been generated.
12. In the moving object control system according to the above embodiments, wherein the speed planning unit increases the speed of the moving object, as the path generated by the path generation unit increases in distance.

According to this embodiment, in a case where the generated path is long, unnecessary deceleration can be avoided.
13. In the moving object control system according to the above embodiments, the system further comprises a direction indication unit configured to receive the direction indication information about the movement destination of the moving object

According to this embodiment, the speed plan in accordance with a course change intended by the user can be generated.
14. In the moving object control system according to the above embodiments, wherein the road shape including the entrance section and at least one exit section accompanied by the course change is any of an intersection, a T junction, and a travel area including an entrance to a facility along a road.

According to this embodiment, the speed plan can be generated to correspond to various road forms.

Heretofore, embodiments of the invention have been described above. The invention is not limited to the foregoing embodiments, and various variations/changes are possible within the spirit of the invention.

What is claimed is:

1. A moving object control system comprising:
an imaging unit configured to acquire a captured image of a travel area to be a movement destination of a moving object;
a recognition unit configured to recognize a road shape included in the captured image;
a path generation unit configured to generate a path of the moving object, based on the road shape recognized by the recognition unit; and
a speed planning unit configured to generate a speed plan of the moving object, based on the path generated by the path generation unit and a recognition situation of the road shape.

2. The moving object control system according to claim 1, wherein upon acquisition of direction indication information accompanied by a course change, the speed planning unit generates the speed plan to start deceleration of the moving object.

3. The moving object control system according to claim 2, wherein when the recognition unit recognizes the road shape including an entrance section, the speed planning unit determines a deceleration value of the moving object in accordance with a distance from a current position of the moving object to the entrance section.

4. The moving object control system according to claim 3, wherein the speed planning unit determines the deceleration value to the entrance section to decelerate a speed of the moving object to a target speed corresponding to each course change direction.

5. The moving object control system according to claim 4, wherein the target speed is further determined in accordance with a curvature of the path generated by the path generation unit.

6. The moving object control system according to claim 4, wherein the target speed is a predetermined value.

7. The moving object control system according to claim 3, wherein the speed planning unit selects the deceleration value from a plurality of discontinuous candidate values.

8. The moving object control system according to claim 7, wherein the speed planning unit changes the deceleration value with a hysteresis.

9. The moving object control system according to claim 3, wherein the speed planning unit further changes the deceleration value in accordance with recognition accuracy of the road shape by the recognition unit.

10. The moving object control system according to claim 9, wherein
the speed planning unit decreases the deceleration value, as the recognition accuracy of the road shape increases, and
the speed planning unit increases the deceleration value, as the recognition accuracy of the road shape decreases.

11. The moving object control system according to claim 4, wherein the speed planning unit further changes the speed of the moving object in accordance with a generation situation of the path by the path generation unit.

12. The moving object control system according to claim 11, wherein the speed planning unit increases the speed of the moving object, as the path generated by the path generation unit increases in distance.

13. The moving object control system according to claim 2, further comprising a direction indication unit configured to receive the direction indication information about the movement destination of the moving object.

14. The moving object control system according to claim 3, wherein the road shape including the entrance section and at least one exit section accompanied by the course change is any of an intersection, a T junction, and a travel area including an entrance to a facility along a road.

15. A control method of a moving object control system, the control method comprising:
acquiring a captured image of a travel area to be a movement destination of a moving object;
recognizing a road shape included in the captured image;
generating a path of the moving object, based on the recognized road shape; and
generating a speed plan of the moving object, based on the generated path and a recognition situation of the road shape.

16. A non-transitory storage medium storing a program for causing a computer to function as:
an imaging unit configured to acquire a captured image of a travel area to be a movement destination of a moving object;
a recognition unit configured to recognize a road shape included in the captured image;
a path generation unit configured to generate a path of the moving object, based on the road shape recognized by the recognition unit; and
a speed planning unit configured to generate a speed plan of the moving object, based on the path generated by the path generation unit and a recognition situation of the road shape.

17. A moving object comprising:
an imaging unit configured to acquire a captured image of a travel area to be a movement destination of a moving object;
a recognition unit configured to recognize a road shape included in the captured image;
a path generation unit configured to generate a path of the moving object, based on the road shape recognized by the recognition unit; and
a speed planning unit configured to generate a speed plan of the moving object, based on the path generated by the path generation unit and a recognition situation of the road shape.
